(19) United States
(12) Patent Application Publication
(10) Pub. No.: US 2024/0266162 A1
(43) Pub. Date: Aug. 8, 2024

(54) VACUUM SYSTEM FOR A MASS SPECTROMETER

(71) Applicant: Micromass UK Limited, Wilmslow (GB)

(72) Inventor: Andrew Whatley, Manchester (GB)

(73) Assignee: Micromass UK Limited, Wilmslow (GB)

(21) Appl. No.: 18/568,165

(22) PCT Filed: Jun. 8, 2022
(86) PCT No.: PCT/GB2022/051435

§ 371 Date: Dec. 7, 2023

(30) Foreign Application Priority Data
Jun. 8, 2021 (GB) 2108151.8
Jun. 8, 2021 (GB) 21081518

(51) Int. Cl. H01J 49/24; H01J 49/00; H01J 49/02; H01J 49/04

(52) U.S. Cl. CPC H01J 49/24; H01J 49/0031; H01J 49/0495; H01J 49/022

(57) ABSTRACT

A mass and/or ion mobility spectrometer comprising: an ion source enclosure; a first vacuum chamber in fluid communication with said ion source enclosure via a first orifice; an isolation valve for at least partially closing said first orifice; a first pump for evacuating the ion source enclosure when the isolation valve is closed; and control circuitry configured to operate the spectrometer in a first mode in which the first pump evacuates the ion source enclosure through a conduit having a gas passage therethrough that is relatively restricted, and to then subsequently operate in a second mode in which the first pump evacuates the ion source enclosure through a conduit having a gas passage therethrough that is less restricted.

### CROSS-REFERENCE TO RELATED APPLICATION

This application claims priority from and the benefit of United Kingdom patent application No. 2108151.8 filed on 8 Jun. 2021, the entire contents of which are incorporated herein by reference.

### FIELD OF THE INVENTION

The present invention relates generally to mass spectrometers and ion mobility spectrometers, and in particular to a method of evacuating various regions of such a spectrometer.

### BACKGROUND

Mass spectrometers and ion mobility spectrometers comprise an ion source enclosure, in which ions from an analytical sample are generated, and a mass and/or mobility analyser for analysing the ions (or ions derived therefrom). The spectrometer may also include various other ion-optical components. Typically, it is desired to operate the analyser(s) and the other ion-optical components at a pressure below atmospheric pressure and hence these components are provided in one or more vacuum chambers that are pumped by one or more vacuum pumps. However, it can be difficult to maintain the vacuum in such vacuum chambers, particularly for example when the ion source enclosure is removed.

### SUMMARY

From a first aspect the present invention provides a mass and/or ion mobility spectrometer comprising: an ion source enclosure; a first vacuum chamber in fluid communication with said ion source enclosure via a first orifice; an isolation valve for at least partially closing said first orifice; and a first pump for evacuating the ion source enclosure when the isolation valve is closed.

The inventor has recognised that by isolating the ion source enclosure from the first vacuum chamber and evacuating the ion source enclosure directly, then problems in the spectrometer vacuum system can be avoided.

The spectrometer may be configured to guide ions from the ion source enclosure, through the first orifice and into the first vacuum chamber (when the isolation valve is open).

The spectrometer may comprise control circuitry configured to operate the spectrometer in a first mode in which the first pump evacuates the ion source enclosure through a conduit having a gas passage therethrough that is relatively restricted, and to then subsequently operate in a second mode in which the first pump evacuates the ion source enclosure through a conduit having a gas passage therethrough that is less restricted.

The provision of the two modes prevents gas passing from the ion source enclosure into the vacuum system at too high a rate, whilst enabling the ion source enclosure to be pumped down relatively quickly.

The first pump may evacuate the ion source enclosure through one or more port in an external wall of the ion source enclosure (i.e. not through an orifice in a wall between the ion source enclosure and the first vacuum chamber).

The spectrometer may comprise a first conduit between the first pump and the ion source enclosure that comprises a first valve, and a second, different conduit between the first pump and the ion source enclosure that comprises a second valve; wherein the spectrometer comprises control circuitry configured such that in a first mode the spectrometer opens the first valve whilst maintaining the second valve closed such that the first pump evacuates the ion source enclosure through the first conduit, and in a second, subsequent mode the spectrometer opens the second valve whilst maintaining the first valve closed such that the first pump evacuates the ion source enclosure through the second conduit; wherein the first conduit provides a gas passage therethrough, when the first valve is open, that is relatively restricted and the second conduit provides a gas passage therethrough, when the second valve is open, that is relatively less restricted.

The amount of restriction provided by a gas passage, at any given time, may be determined by the minimum cross-sectional area of the gas passage in the conduit at that time. For example, each valve described herein may provide an aperture that is openable and closable, and the minimum cross-sectional area may be defined by the cross-sectional area of the aperture provided by the valve. In such embodiments the first and second valves may provide apertures of different cross-sectional areas (e.g. when fully open). Alternatively, the first and second conduits may have the same valves, but the gas passages through the different conduits may have different minimum cross-sectional areas at locations other than at the valves.

Alternatively, or additionally, it is contemplated that the gas flow rate may be controlled by the number of conduits between the ion source enclosure and the first pump that are open, i.e. the different conduits may or may not be restricted by different amounts (when open).

Accordingly, the spectrometer may comprise a first conduit between the first pump and the ion source enclosure that comprises a first valve, and a second, different conduit between the first pump and the ion source enclosure that comprises a second valve; wherein the spectrometer comprises control circuitry configured such that in a first mode the spectrometer opens the first valve whilst maintaining the second valve closed such that the first pump evacuates the ion source enclosure through the first conduit, and in a second, subsequent mode the spectrometer opens both the first and second valves such that the first pump evacuates the ion source enclosure through both the first and second conduit.

The spectrometer may comprise a conduit between the first pump and the ion source enclosure that comprises a valve for controlling the gas flow rate through the conduit, and comprising control circuitry configured to control the valve to open by a first amount in a first mode and to open by a greater amount for a second, subsequent mode.

These embodiments provide different levels of restriction using only a single conduit.

The valve may be held open by said first amount for a predetermined period of time (e.g. ≥1 s, ≥5 s, ≥10 s, ≥15 s, ≥30 s, ≥60 s) or until the ion source enclosure has dropped to a predetermined pressure. Subsequently, the valve may be held open by said greater amount for a predetermined period of time (e.g. ≥1 s, ≥5 s, ≥10 s, ≥15 s, ≥30 s, ≥60 s) or until the ion source enclosure has dropped to a predetermined pressure.

The spectrometer may be configured to switch from operating in said first mode to starting to operate in said second mode when the pressure in the ion source enclosure has decreased to a first threshold pressure, or after a first pre-set amount of time.

The spectrometer may therefore comprise a pressure sensor in the ion source enclosure.

The spectrometer may be configured to open the isolation valve when the pressure in the ion source enclosure has decreased to a second threshold pressure that is lower than the first threshold pressure, or after a second pre-set amount of time that is longer than the first pre-set amount of time.

The isolation valve may be configured to prevent (or reduce) gas flow from the ion source enclosure to the first vacuum chamber when the isolation valve is closed, and to allow (or increase) gas flow from the ion source to the first vacuum chamber when the isolation valve is opened.

The ion source enclosure and the first vacuum chamber may be directly adjacent one another, e.g. with said first orifice in a wall therebetween. Alternatively, one or more further vacuum chamber may be arranged between the ion source enclosure and the first vacuum chamber.

The spectrometer may comprise control circuitry configured to control the spectrometer such that the first pump is able to start evacuating the ion source enclosure only after the isolation valve has been closed. For example, the spectrometer may be configured to open said first valve (or the valve in the embodiments having a single conduit) only after the isolation valve has been closed.

The ion source enclosure may house a target plate for holding an analytical sample to be ionised.

The ion source enclosure may house a MALDI target plate, such as a MALDI plate having sample wells in a microtitre format.

The spectrometer may therefore have a laser or other device for ionising the sample on the target plate.

Alternatively, the ion source may be another type of ion source, e.g. having a target plate, such as a DESI source.

As the present invention provides an isolation valve for closing off the first orifice when the ion source enclosure is removed, the first orifice can be made relatively large without being concerned about gas flow through the first orifice. This relatively large first orifice is beneficial for enabling ions to be transferred from the ion source enclosure to the first vacuum chamber (through the first orifice), when the isolation valve is open. This is particularly the case in spectrometers having a target plate in the ion source, which tends to produce a rather diffuse ion cloud in the ion source.

The first orifice may have a diameter of ≥15 mm; ≥16 mm; ≥17 mm; ≥18 mm; ≥19 mm; or ≥20 mm.

The first orifice may be circular. Alternatively, it may be another shape. In any event, the first orifice may have a cross-sectional area of ≥300 mm², ≥310 mm², or ≥320 mm².

It is contemplated that the ion source enclosure may not house a target plate, but may instead house an ionisation device configured to generate ions from an analytical sample.

The ion source enclosure, when mounted to the first vacuum chamber, may define an enclosed region having a void volume of 50 cc. For example, the void volume may be ≥50 cc, ≥60 cc, ≥70 cc, ≥80 cc, ≥90 cc, ≥100 cc, ≥120 cc, ≥140 cc, ≥160 cc, ≥180 cc, or ≥200 cc.

The void volume is volume that of the enclosure in which gas may be present. By providing the pumping techniques described herein, the void volume may be relatively large without encountering the problems described herein.

The spectrometer may comprise a second vacuum chamber arranged downstream of the first vacuum chamber and in fluid communication with said first vacuum chamber via a second orifice.

Ions may be transported from the first vacuum chamber to the second vacuum chamber via the second orifice.

The first pump may be connected to the first vacuum chamber (e.g. through a port in an external wall thereof) in addition to being connected to the ion source enclosure, for evacuating the first vacuum chamber.

The spectrometer may comprise a second pump having an inlet for evacuating the first vacuum chamber and/or an inlet for evacuating the second vacuum chamber, and one or more outlet for expelling the gas evacuated from the first and/or second vacuum chamber; wherein the one or more outlet of the second pump is connected to the inlet of the first pump.

This configuration enables the first pump to maintain the outlet of the second pump at a pressure below atmospheric pressure, such that it is easier for the second pump to evacuate the first and/or second vacuum chambers.

The spectrometer may be configured to pump the first vacuum chamber to a lower pressure than the ion source enclosure.

The spectrometer may be configured to pump the second vacuum chamber to a lower pressure than the first vacuum chamber.

The second pump is a turbomolecular pump and/or the first pump may be a roughing pump.

The roughing pump may be a rotary, diaphragm or scroll pump, or any other type of pump suitable for pumping the backing line of the spectrometer.

The spectrometer may be configured such that the ion source enclosure is removably mounted to the first vacuum chamber about said first orifice such that the ion source enclosure is repeatedly mountable to, and demountable from, the first vacuum chamber.

The spectrometer may comprise a vent valve for venting the ion source enclosure to atmospheric pressure, and comprising circuitry configured to open the vent valve so as to vent the ion source enclosure only after the isolation valve is closed.

Conversely, the spectrometer may be configured so as to prevent the isolation valve opening until the ion source enclosure is mounted on the first vacuum chamber and the vent valve is closed.

The present invention also provides a method of mass and/or ion mobility spectrometer comprising: providing a spectrometer as claimed described herein; mounting the ion source enclosure to the first vacuum chamber about said first orifice; maintaining said isolation valve in a closed position so as to prevent or reduce gas flow from the ion source enclosure into the first vacuum chamber; and operating said first pump so as to evacuate the ion source enclosure whilst the isolation valve is closed.

Said step of operating said first pump so as to evacuate the ion source enclosure may comprise: operating the spectrometer in a first mode in which the first pump evacuates the ion source enclosure through a conduit having a gas passage therethrough that is relatively restricted, and then subsequently operating the spectrometer in a second mode in which the first pump evacuates the ion source enclosure through a conduit having a gas passage therethrough that is less restricted.

Alternatively, or additionally, it is contemplated that the gas flow rate may be controlled by the number of conduits between the ion source enclosure and the first pump that are open, i.e. the different conduits may or may not be restricted by different amounts (when open).

Accordingly, said step of operating said first pump so as to evacuate the ion source enclosure may comprise: operating the spectrometer in a first mode in which the first pump evacuates the ion source enclosure through a first conduit, and then subsequently operating the spectrometer in a second mode in which the first pump simultaneously evacuates the ion source enclosure through both a first and second conduit.

It is contemplated that the first pump need not necessarily evacuate an ion source enclosure, but may instead evacuate another enclosed region such as a vacuum chamber that is downstream of the ion source enclosure.

Additionally, or alternatively, in less preferred embodiments the spectrometer may not require said isolation valve.

Accordingly, from a second aspect the present invention provides a mass and/or ion mobility spectrometer comprising: an enclosed region; a first vacuum chamber in fluid communication with said enclosed region via a first orifice; a first pump for evacuating the enclosed region; and control circuitry configured to operate the spectrometer in a first mode in which the first pump evacuates the enclosed region through a conduit having a gas passage therethrough that is relatively restricted, and to then subsequently operate in a second mode in which the first pump evacuates the enclosed region through a conduit having a gas passage therethrough that is less restricted.

The enclosed region may be a vacuum chamber that is arranged upstream of, and may be maintained at a higher pressure than, the first vacuum chamber.

The spectrometer may comprise an isolation valve for at least partially closing said first orifice. The spectrometer may be configured to evacuate the enclosed region when the isolation valve is closed.

The spectrometer according to the second aspect of the invention may have any of the features described above in relation to the first aspect of the invention, except that the ion source enclosure may be another enclosed or non-enclosed region and/or the isolation valve may not be required.

### BRIEF DESCRIPTION OF THE DRAWINGS

Various embodiments of the present invention will now be described, by way of example only, and with reference to the accompanying drawings in which:

FIG. 1 shows a schematic of a known spectrometer; and

FIG. 2 shows a schematic of a spectrometer according to an embodiment of the present invention.

### DETAILED DESCRIPTION

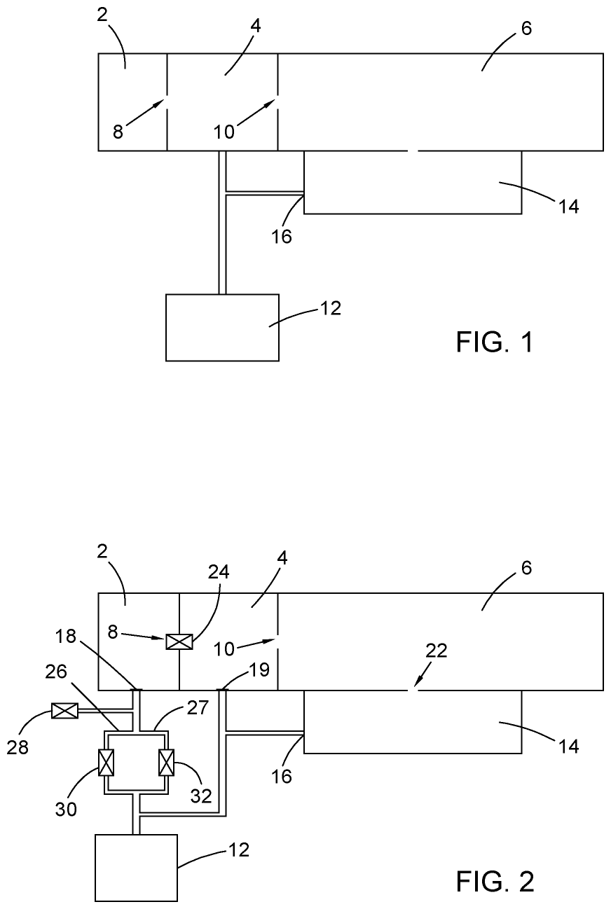

FIG. 1 shows a schematic of a known spectrometer for help in understanding the present invention. The spectrometer comprises an ion source enclosure 2, a first vacuum chamber 4 and a second vacuum chamber 6. An first (inlet) orifice 8 is provided in the upstream wall of the first vacuum chamber 4 so as to allow ions to enter the first chamber 8 from the ion source enclosure 2. A mass analyser (not shown) is arranged in the second vacuum chamber 6. A second orifice 10 is arranged in the wall between the first and second vacuum chambers such that the ions can pass from the first vacuum chamber 4 into the second vacuum chamber 6 and then into the mass analyser arranged therein.

A roughing pump or backing pump 12 is connected to the first vacuum chamber 4 for evacuating the first vacuum chamber 4. This pump reduces the pressure in the first vacuum chamber 4 to a pressure below atmospheric pressure. A turbomolecular pump 14 is connected to the second vacuum chamber 6 for evacuating the second vacuum chamber 6 to a pressure below that of the first vacuum chamber 4. It is typically desired to reduce the pressure in the second vacuum chamber 6 to a very low pressure in order for the mass analyser housed therein to operate optimally.

It will be appreciated that reducing the pressure in the first vacuum chamber 4 using the roughing pump 12 enables the turbomolecular pump 14 to evacuate the second vacuum chamber 6 more easily, since the gas flow rate from the first vacuum chamber 4 into the second vacuum chamber 6 is lower. However, turbomolecular pumps are not able to efficiently pump gas from a vacuum chamber out to a region that is at atmospheric pressure. Accordingly, the roughing pump 12 is connected to the outlet 16 of the turbomolecular pump 14 so that the roughing pump 12 can pump the outlet 16 of the turbomolecular pump down to a pressure of a few milli-bars. This process is known in the art as the roughing pump (or “backing pump”) backing the turbomolecular pump 14.

In use, the ion source in the ion source enclosure 2 ionises an analytical sample so as to produce ions. The ions then pass from the relatively high pressure ion source enclosure 2, through the first orifice 8, and into the lower pressure first vacuum chamber 4. The ions are then guided through the first vacuum chamber 4 by an ion guide and into the lower pressure second vacuum chamber 6, wherein they are guided into the mass analyser.

From time to time, it may be desired to remove the ion source enclosure 2 from the first vacuum chamber 4 for various reasons. However, if the ion source enclosure 2 is removed, this results in a large pressure differential across the first orifice 8 and so causes a relatively high gas flow rate into the first vacuum chamber 4 through the first orifice 8. This causes the pressure in the first vacuum chamber 4 to rise and hence increase the gas flow rate through the second orifice 10 and into the second vacuum chamber 6. As such, the second pump 14 may be unable to maintain the desired pressures in the first and second vacuum chambers. Worse still, such pressure changes are likely to cause the spectrometer to go into a crash vent mode, in which vents are opened so that the vacuum chambers 4, 6 are allowed to rise to atmospheric pressure. If this occurs, then once the ion source enclosure 2 has been remounted on the first vacuum chamber 4, the pumps will need to pump the vacuum chambers 2, 4 back down from atmospheric pressure to their desired operational pressures. Given that the pressure in the second vacuum chamber 4 can be of the order of, for example, 10⁻⁷ millibar (e.g. if housing a Time of Flight mass analyser), it can take several hours to pump the spectrometer back down.

FIG. 2 shows a schematic of a spectrometer according to an embodiment of the present invention. The spectrometer comprises an ion source enclosure 2, a first vacuum chamber 4 and a second vacuum chamber 6. A first (inlet) orifice 8 is provided in the upstream wall of the first vacuum chamber 4 so as to allow ions to enter the first vacuum chamber 4 from the ion source enclosure 2. An ion guide may be arranged in the first vacuum chamber 4 for guiding ions from the ion source enclosure 2 to pass through the first vacuum chamber 4 and into the second vacuum chamber 6. A second orifice 10 is provided in the wall between the first and second vacuum chambers 4, 6 so as to allow ions pass from the first vacuum chamber 4 into the second vacuum chamber 6. One or more ion-optical components are arranged in the second vacuum chamber 6. For example, an ion mobility separator and/or a mass analyser may be arranged in the second vacuum chamber 6 for analysing ions transmitted from the first vacuum chamber 4 into the second vacuum chamber 6 (or for analysing ions derived from those ions, e.g. their fragment or product ions). Additional ion-optical components may also be arranged in the second vacuum chamber 6, e.g. upstream of the an ion mobility separator and/or mass analyser. For example, one or more of the following may be arranged in the second vacuum chamber 6: at least one ion guide; at least one ion trap, at least one fragmentation or reaction cell or device for fragmenting or reacting ions so as to form fragment or production ions; and a mass filter. An ion detector may also be provided in the second vacuum chamber, e.g. as part of the mass analyser.

A first vacuum pump 12, such as a roughing pump (also known as a backing pump), may be connected to a port 18 in the ion source enclosure 2. This first pump 12 is configured to reduce the pressure in the ion source enclosure 2 to a pressure below atmospheric pressure. The first pump 12 may be, for example, a rotary pump or a diaphragm pump. The first pump 12 may also be connected to a port 19 in the first vacuum chamber 4 so as to reduce the pressure therein. A second vacuum pump 14, such as a turbomolecular pump, may be directly connected to a port 22 in the second vacuum chamber 6 for evacuating the second vacuum chamber 6. The second pump 14 evacuates the second vacuum chamber to a pressure below that of the first vacuum chamber 4, e.g. to a very low pressure in order for a mass analyser housed therein to operate optimally. For example, the second vacuum chamber 6 may house a time of flight mass analyser and may therefore be required to be pumped down to a pressure in the range of 10⁻⁶ to 10⁻⁸ mbar, or lower, in order to operate optimally.

An isolation valve 24 is provided between the ion source enclosure 2 and the first vacuum chamber 4 for closing the first orifice 8 so as to prevent gas flow between the ion source enclosure 2 and the first vacuum chamber 4 when the isolation valve 24 is closed, and for opening the first orifice 8 when the isolation valve 24 is open. The purpose of this isolation valve 24 will become clear from the description further below.

It will be appreciated that reducing the pressure in the ion source enclosure 2 and first vacuum chamber 4 using the first pump 12 enables the second pump 14 to evacuate the second vacuum chamber 6 more easily, since the gas flow rate from the first vacuum chamber 4 into the second vacuum chamber 6 is lower than if the first vacuum chamber 4 was not pumped down. The ion source enclosure 2 and first vacuum chamber 4 may be pumped down to a pre-selected pressure by the first pump 12 before the second pump 14 is started. As shown in FIG. 2, the inlet line to the first pump 12 is connected to the ion source enclosure 2 via two conduits 26, 27 for pumping down the ion source enclosure 2. The functions of the two conduits which will be described in more detail further below.

The inlet line to the first pump 12 may not only be connected to the ion source enclosure 2 in order to evacuate it, but the inlet line (also known as the backing line) may also be connected to the outlet 16 of the second pump 14 so that the first pump 12 can pump the outlet 16 of the second pump 14 down, e.g. to a pressure of a few milli-bars. This makes it easier for the second pump 14 to achieve the desired low pressure in the second vacuum chamber 6.

In operation, once the ion source enclosure 2 and vacuum chambers 4, 6 have been pumped down to their desired operational pressures, the ion source in the ion source enclosure 2 ionises an analytical sample so as to produce ions. The ions then pass from the ion source enclosure 2, through the first orifice 8 (as isolation valve 24 is open), and into the first vacuum chamber 4. The ions are then guided through the first vacuum chamber 4 by an ion guide and into the lower pressure second vacuum chamber 6, wherein they are guided into an ion mobility analyser and/or mass analyser. As described above, the ions may be manipulated upstream of such analysers by other ion-optical devices arranged in the first and/or second vacuum chambers 4, 6.

From time to time it may be desired to remove the ion source enclosure 2 from the first vacuum chamber 4. For example, if the ion source is a MALDI ion source or another type of ion source having a target plate or sample plate, such as a DESI source, then it may be required to remove the ion source enclosure 2 from the first vacuum chamber 4 in order to change the target or sample plate or replenish it with more sample. Alternatively, it may be desired to change the ion source for a different type of ion source. For example, a first type of ion source (e.g. ESI ion source) may be used when setting up (e.g. calibrating) the spectrometer, but then a second, different type of ion source (e.g. a MALDI ion source) may be required or desired for ionising an analytical sample. Alternatively, it may be necessary to remove the ion source in order to replace, clean or otherwise maintain one or more components of the ion source or first vacuum chamber 4. For example, it may be necessary to clean the first aperture 8 between the ion source enclosure 2 and first vacuum chamber 4 if it becomes contaminated or blocked.

In order to remove the ion source enclosure 2, a vent valve 28 may be opened so as to allow the pressure in the ion source enclosure 2 to rise until atmospheric pressure. However, if the ion source enclosure 2 is then removed (whilst the first vacuum chamber 4 is evacuated), this will result in an increased pressure differential across the first orifice 8 and so will cause a relatively high gas flow rate into the first vacuum chamber 4 through the first orifice 8. This would cause the pressure in the first vacuum chamber 4 to rise and hence increase the gas flow rate through the second orifice 10 and into the second vacuum chamber 6. As such, the second pump 14 may be unable to maintain the desired pressure in the second vacuum chamber. Worse still, such pressure changes are likely to cause the spectrometer to go into a crash vent mode, in which vents are opened so that the vacuum chambers 4, 6 are allowed to rise to atmospheric pressure. If this occurs, then once the ion source enclosure 2 has been remounted on the first vacuum chamber 4, the pumps 12, 14 will need to pump the vacuum chambers 4, 6 back down from atmospheric pressure to their desired operational pressures. Given that the pressure in the second vacuum chamber 6 can be of the order of, for example, 10⁻⁷ or even 10⁻⁸ millibar (e.g. if housing a Time of Flight mass analyser), it can take several hours to pump the spectrometer back down.

In order to mitigate some of the above problems, an isolation valve 24 may be provided between the ion source enclosure 2 and the first vacuum chamber 4, which is selectively operable so as to close the first orifice 8 and prevent gas flow from the ion source enclosure 2 to the first vacuum chamber 4. The isolation valve 24 (and valves 30, 32) may be closed prior to removing the ion source enclosure 2 from the first vacuum chamber 4. As such, when the ion source enclosure 2 is removed there will be no gas flow through the first orifice 8 and so the first and second pumps 12, 14 are able to maintain the first and second vacuum chambers 4, 6 at their desired pressures. When the ion source enclosure 2 is remounted to the first vacuum chamber 4 (and the vent valve 28 closed) the first pump 12 is then able to pump the ion source enclosure 2 back down to its desired pressure, as will be described below. Once the ion source enclosure 2 has returned to its operational pressure, the isolation valve 24 is then opened such that ions are able to pass from the ion source enclosure 2 to the first vacuum chamber 4 and the spectrometer is able to be used to analyse ions again.

However, it has been recognised that if an ion source enclosure 2 is used that has a relatively large void volume when mounted to the first vacuum chamber 4, then problems can still be encountered. For example, if an ion source enclosure 2 having relatively large volume is mounted to the first vacuum chamber 4, then the first pump 12 will evacuate a relatively high volume of gas from the ion source enclosure 2 in a relatively short time. This can cause the pressure in the inlet line to the first pump 12 (i.e. the backing line) to increase to a relatively high value, which can cause problems. For example, if the inlet of the first pump 12 (i.e. the backing line) is connected to the outlet 16 of the second pump 14 in order to assist the second pump 14 in pumping down the second vacuum chamber 6, then the increase in pressure will put strain on the second pump 14. The second pump 14 may be unable to maintain the desired low pressure in the second vacuum chamber 6, which may cause problems. For example, the increased pressure may result in electrical arcing or voltage break-down in the second vacuum chamber 6 due to the high voltages that may be applied to ion-optical components therein. In scenarios such as these the spectrometer may switch to a crash vent mode in which vents are opened so that the vacuum chambers 4, 6 are allowed to rise to atmospheric pressure. As such, the entire vacuum system will need to be pumped down again to operational pressures, which can take several hours.

Historically, this problem has not been recognised, particularly as most conventional ion source enclosures are relatively small. For example, a conventional MALDI sample plate is approximately the size of a credit card and hence the ion source enclosure is relatively small. In contrast, it may now be desired to use relatively large ion source enclosures 2, such as ion sources having relatively large target plates (e.g. large microtitre MALDI sample plates).

Embodiments of the present invention mitigate the above problem by pumping down the ion source enclosure 2 in a manner that varies with time.

As described above, the isolation valve 24 may be closed and the ion source enclosure 2 removed from the first vacuum chamber 4. Once the ion source enclosure 2, or another ion source enclosure 2, has been remounted on the first vacuum chamber 4, it is desired to pump the ion source enclosure 2 down in a manner that avoids the pressure in the backing line significantly increasing.

Referring back to FIG. 2, the first pump 12 is connected to the ion source enclosure 2 by two different conduits 26, 27, each for pumping down the ion source enclosure 2. Each of the conduits has a pump valve 30, 32 therein, which is selectively openable and closable so as to selectively open and close the conduits 26, 28 between the first pump 12 and the ion source enclosure 2. The (first) pump valve 30 in the first conduit 26 is configured to restrict the gas flow therethrough, when the first pump valve 30 is open, by a greater amount than the (second) pump valve 32 in the second conduit 27 restricts the gas flow therethrough, when the second pump valve 32 is open (assuming the same pressure differential across the first and second conduits). For example, each of the pump valves 30, 32 may open and close an aperture in its respective conduit 26, 27, wherein the aperture controlled by the first pump valve 30 has a smaller area than the aperture controlled by the second pump valve 32.

In operation, when it is desired to pump down the ion source enclosure 2, the spectrometer is operated in a first mode in which the first pump valve 30 is maintained open and the second pump valve 32 is maintained closed. This provides a relatively restricted gas flow path from the ion source enclosure 2 to the first gas pump 12 via the first conduit 26. This restricted gas flow path provides a relatively low gas flow rate from the ion source enclosure 2 to the backing line and so ensures that the pressure in the backing line does not rise significantly. After a period of time, such as a pre-set period of time or after the ion source has dropped below a pre-set pressure, the spectrometer operates in a second mode in which the control circuitry closes the first pump valve 30 so as to prevent gas flow through the first conduit 26 and opens the second pump valve 32 so as to allow gas flow through the second conduit 27. The second conduit 27 provides a relatively less restrictive gas flow path from the ion source enclosure 2 to the backing line, which enables the ion source enclosure 2 to be pumped down to the desired pressure relatively quickly. However, as the pressure in the ion source enclosure 2 is relatively low when the second pump valve 32 is opened, the gas flow rate through the second conduit 27 is relatively low and so does not cause the pressure in the backing line to rise excessively. It is also contemplated that after a further period of time, such as a pre-set period of time or after the ion source has dropped below a further pre-set pressure, the spectrometer may operate in a third mode in which the control circuitry opens both the first and second pump valves 30, 32 so as to allow gas flow through the first and second conduits 26, 27. This third mode may be used to pump the ion source enclosure 2 down to the desired pressure even more quickly.

The timings at which the first and second pump valves 30, 32 are opened and closed, and the duration that each pump valve is opened for, is controlled by circuitry in the spectrometer such that the backing line does not increase in pressure to a level that will cause a crash vent or otherwise adversely affect the operation of the second pump 14. This limits the stress that the second pump 14 is exposed to, but also ensures that the pressure in the first and second vacuum chambers 4, 6 does not rise, or does not rise excessively.

As described above, once the ion source enclosure 2 has been pumped down the isolation valve 24 may be opened again and the spectrometer may be used to ionise a sample and analyse the ions produced therefrom.

Although the present invention has been described with reference to various embodiments, it will be understood by those skilled in the art that various changes in form and detail may be made without departing from the scope of the invention as set forth in the accompanying claims.

For example, although an embodiment has been described having two differently restricted conduits 26, 27 for enabling the first pump 12 to evacuate the ion source enclosure 2, it is contemplated that a greater number of differently restricted conduits may be provided between the first pump 12 and ion source enclosure 2.

Conversely, it is also contemplated that only a single conduit may be provided between the first pump 12 and the ion source enclosure 2 for evacuating the ion source enclosure 2. In this embodiment the conduit may have a variable pump valve located therein that is configured to be operable in a first mode in which the pump valve provides a relatively great restriction to a gas flow through the conduit, and to then be operable in a second mode in which the pump valve provides a lesser restriction to a gas flow through the conduit. For example, in the first mode the pump valve may initially provide a relatively small aperture in the conduit for gas to flow through and may then be operated so that in the second mode the pump valve provides a larger aperture in the conduit for gas to flow though.

Although only two vacuum chambers 4, 6 downstream of the ion source enclosure 2 are shown and described above, it will be appreciated that one or more further vacuum chambers may be provided downstream of the ion source enclosure 2. For example, one or more further vacuum chamber may be arranged between the first and second vacuum chambers 4, 6, with inter-chamber orifices in the walls between adjacent chambers so as to allow ions to pass through all of the vacuum chambers. These additional vacuum chambers may be at different pressures to the first and second vacuum chambers, such as at pressures intermediate those of the first and second vacuum chambers. These additional vacuum chambers may be pumped down by the second pump 14 or by one or more other vacuum pump.

1. A mass and/or ion mobility spectrometer comprising:
an ion source enclosure;
a first vacuum chamber in fluid communication with said ion source enclosure via a first orifice;
an isolation valve for at least partially closing said first orifice;
a first pump for evacuating the ion source enclosure when the isolation valve is closed; and
control circuitry configured to operate the spectrometer in a first mode in which the first pump evacuates the ion source enclosure through a conduit having a gas passage therethrough that is relatively restricted, and to then subsequently operate in a second mode in which the first pump evacuates the ion source enclosure through a conduit having a gas passage therethrough that is less restricted.

2. The spectrometer of claim 1, comprising a first conduit between the first pump and the ion source enclosure that comprises a first valve, and a second, different conduit between the first pump and the ion source enclosure that comprises a second valve; wherein the spectrometer comprises control circuitry configured such that in a first mode the spectrometer opens the first valve whilst maintaining the second valve closed such that the first pump evacuates the ion source enclosure through the first conduit, and in a second, subsequent mode the spectrometer opens the second valve whilst maintaining the first valve closed such that the first pump evacuates the ion source enclosure through the second conduit; wherein the first conduit provides a gas passage therethrough, when the first valve is open, that is relatively restricted and the second conduit provides a gas passage therethrough, when the second valve is open, that is relatively less restricted.

3. The spectrometer of claim 1, comprising a first conduit between the first pump and the ion source enclosure that comprises a first valve, and a second, different conduit between the first pump and the ion source enclosure that comprises a second valve; wherein the spectrometer comprises control circuitry configured such that in a first mode the spectrometer opens the first valve whilst maintaining the second valve closed such that the first pump evacuates the ion source enclosure through the first conduit, and in a second, subsequent mode the spectrometer opens both the first and second valves such that the first pump evacuates the ion source enclosure through both the first and second conduit.

4. The spectrometer of claim 1, comprising a conduit between the first pump and the ion source enclosure that comprises a valve for controlling the gas flow rate through the conduit, and comprising control circuitry configured to control the valve to open by a first amount in a first mode and to open by a greater amount for a second, subsequent mode.

5. The spectrometer of claim 1, wherein the spectrometer is configured to switch from operating in said first mode to starting to operate in said second mode when the pressure in the ion source enclosure has decreased to a first threshold pressure, or after a first pre-set amount of time.

6. The spectrometer of claim 5, wherein the spectrometer is configured to open the isolation valve when the pressure in the ion source enclosure has decreased to a second threshold pressure that is lower than the first threshold pressure, or after a second pre-set amount of time that is longer than the first pre-set amount of time.

7. The spectrometer of claim 1, comprising control circuitry configured to control the spectrometer such that the first pump is able to start evacuating the ion source enclosure only after the isolation valve has been closed.

8. The spectrometer of claim 1, wherein the ion source enclosure houses a target plate for holding an analytical sample to be ionised.

9. The spectrometer of claim 8, wherein the ion source enclosure houses a MALDI target plate, such as a MALDI plate having sample wells in a microtitre format.

10. The spectrometer of claim 1, wherein the first orifice has a diameter of ≥15 mm; ≥16 mm; ≥17 mm; ≥18 mm; ≥19 mm; or ≥20 mm.

11. The spectrometer of claim 1, wherein the ion source enclosure, when mounted to the first vacuum chamber, defines an enclosed region having a void volume of ≥50 cc.

12. The spectrometer of claim 1, comprising a second vacuum chamber arranged downstream of the first vacuum chamber and in fluid communication with said first vacuum chamber via a second orifice.

13. The spectrometer of claim 1, comprising a second pump having an inlet for evacuating the first vacuum chamber and/or an inlet for evacuating the second vacuum chamber, and one or more outlet for expelling the gas evacuated from the first and/or second vacuum chamber; wherein the one or more outlet of the second pump is connected to the inlet of the first pump.

14. The spectrometer of claim 13, wherein the second pump is a turbomolecular pump.

15. The spectrometer of claim 1, wherein the first pump is a roughing pump.

16. The spectrometer of claim 1, wherein the spectrometer is configured such that the ion source enclosure is removably mounted to the first vacuum chamber about said first orifice such that the ion source enclosure is repeatedly mountable to, and demountable from, the first vacuum chamber.

17. The spectrometer of claim 1, comprising a vent valve for venting the ion source enclosure to atmospheric pressure, and comprising circuitry configured to open the vent valve so as to vent the ion source enclosure only after the isolation valve is closed.

18. A method of mass and/or ion mobility spectrometer comprising:
providing a spectrometer as claimed in claim 1;
mounting the ion source enclosure to the first vacuum chamber about said first orifice;
maintaining said isolation valve in a closed position so as to prevent or reduce gas flow from the ion source enclosure into the first vacuum chamber; and
operating said first pump so as to evacuate the ion source enclosure whilst the isolation valve is closed by operating the spectrometer in a first mode in which the first pump evacuates the ion source enclosure through a conduit having a gas passage therethrough that is relatively restricted, and then subsequently operating the spectrometer in a second mode in which the first pump evacuates the ion source enclosure through a conduit having a gas passage therethrough that is less restricted.

19. The method of claim 18, wherein said step of operating said first pump so as to evacuate the ion source enclosure comprises: operating the spectrometer in a first mode in which the first pump evacuates the ion source enclosure through a first conduit, and then subsequently operating the spectrometer in a second mode in which the first pump simultaneously evacuates the ion source enclosure through both a first and second conduit.
